(19) United States
(12) Patent Application Publication
(10) Pub. No.: US 2004/0163582 A1
(43) Pub. Date: Aug. 26, 2004

(54) Rescue device with kite-type balloon marker, kite-type balloon & method

(76) Inventors: Lee Willis, Huntington Beach, CA (US); Martin Barteske, Huntington Beach, CA (US)

Correspondence Address: CONNORS ASSOCIATES, 1600 DOVE ST, SUITE 220, NEWPORT BEACH, CA, 92660

(21) Appl. No.: 10/780,099

(22) Filed: Feb. 17, 2004

Related U.S. Application Data
(60) Provisional application No. 60/448,759, filed on Feb. 20, 2003.

(51) Int. Cl. B64B 1/40

(52) U.S. Cl. 116/210

(57) ABSTRACT

An individual's location is marked to facilitate rescue even under windy weather conditions by using a device including a deflated kite-type balloon attached to a secured line. When rescue is desired, the deflated kite-type balloon is inflated with lighter than air gas and released while secured by the line.

### RELATED PATENT APPLICATIONS & INCORPORATION BY REFERENCE

This application is a utility application based on U.S. provisional patent application Serial No. 60/448,759, entitled “Rescue Device With Kite-Type Balloon Marker, Kite-Type Balloon, & Method,” filed Feb. 20, 2003. This related application is incorporated herein by reference and made a part of this application. If any conflict arises between the disclosure of the invention in this utility application and that in the related provisional application, the disclosure in this utility application shall govern. Moreover, the inventors incorporate herein by reference any and all U.S. patents, U.S. patent applications, and other documents cited or referred to in this application or cited or referred to in the U.S. patents and U.S. patent applications incorporated herein by reference.

### DEFINITIONS

The words “comprising,” “having,” “containing,” and “including,”and other forms thereof, are intended to be equivalent in meaning and be open ended in that an item or items following any one of these words is not meant to be an exhaustive listing of such item or items, or meant to be limited to only the listed item or items.

“Kite-type balloon” means a balloon including kite structure that enables the balloon to remain aloft under windy weather conditions.

### BACKGROUND OF INVENTION

U.S. Pat. No. 5,582,127 discloses a rescue device that holds within a housing a compacted balloon that is released from the housing and inflated upon removing a detachable cover closing an open end of the housing. As the balloon is inflated it escapes from the open end. A line secured between the balloon and the device keeps the balloon in the vicinity of a lost or injured person. The released balloon hovers aloft in the vicinity of the lost or injured person to identify his or her location. Under some weather conditions, particularly under very windy weather conditions, the balloon fails to remain aloft.

### SUMMARY OF INVENTION

This invention has one or more features as discussed subsequently herein. After reading the following section entitled “DETAILED DESCRIPTION OF SOME EMBODIMENTS OF THIS INVENTION,” one will understand how the features of this invention provide its benefits. These benefits include, but are not limited to: providing a reliable rescue device using a kite-type balloon that remains elevated even in windy weather conditions.

Without limiting the scope of this invention as expressed by the claims that follow, some, but not necessarily all, of its features are:

One, the rescue device that marks the location of lost or injured person comprises a kite-type balloon having a self-sealing inflation port. When inflated, secured by a line, and then released, this kite-type balloon hovers aloft in the vicinity of the lost or injured person to identify his or her location, even under windy weather conditions.

Two, the device may include a housing that retains the balloon in a deflated, predetermined compact condition. The housing may enclose a container of pressurized, lighter than air gas, an inflator valve a detachable cover member closing an open end of the housing, and a valve actuator connected to the cover member. Upon removal of the cover member from the open end of the housing, the valve actuator opens the inflator valve, causing the lighter than air gas to enter the compacted balloon to inflate the balloon, which exits the open end of the housing solely under the influence of the pressurized gas.

Three, the balloon may have different configurations, for example, in one embodiment it has a substantially triangular configuration. In many configurations, the balloon has opposed faces, opposed lateral sides, opposed ends, and a longitudinal axis extending between the opposed ends. The balloon may be substantially symmetrical about this axis. The inflation port may be nearby one of the ends of the balloon. In one embodiment, at least a portion of the balloon is radar reflective. The balloon may include a central hollow body adapted to be filled with the gas. In one embodiment, the inflatable body may have a substantially cross configuration with a pair of opposed arms intersecting a beam element. The arms have outer ends, and a pair of sail elements may be attached to the arms. Each sail element may be connected to one arm and to a side of the beam element. The sail elements may have a substantially triangular configuration and they may have an outer edge tapering inward to terminate at or near a tail end of the balloon.

Four, one or more lines may be used with the device. In one embodiment, each arm of the balloon body has an outer end and a first connector line extends between the outer ends and a second connector line extends between a head end of the balloon and an intermediate portion of the first connector line. A third line adapted to secure the balloon at or near the location of the person being rescued has an end connected to an intermediate portion of the first connector line. With the balloon in the predetermined compact condition, a portion of the third line extends outward from the compacted balloon.

Five, the deflated balloon in the housing is in a predetermined compact condition. In this compact condition, each of the lateral sides of the balloon are rolled inward against one of the balloon's faces and towards the longitudinal axis so that the balloon is a partially rolled balloon. This partially rolled balloon is then rolled inward from the end opposed to the inflation port, towards the inflation port, into the predetermined compact condition.

Six, the balloon may include a tail. This tail may be attached to a tail end of the hollow body and the self-sealing inflation port may be near this tail end or near a head end of the hollow body. The tail may have a length that when folded inward does not intersect with the first connector line.

These features are not listed in any rank order nor is this list intended to be exhaustive.

This invention also includes a method of marking an individual's location to facilitate rescue even under windy weather conditions. Central to this method is the use of a kite-type balloon having a self-sealing inflation port adapted to be placed in communication with a source of lighter than air gas to inflate the kite-type balloon. A line secures the balloon at the location, so the inflated balloon hovers above the location at or nearby the person being rescued. When rescue is desired, the deflated kite-type balloon is inflated and released. If a portion of the balloon is radar reflective, radar may be used to locate the balloon hovering aloft in the vicinity of the person being rescued.

### DESCRIPTION OF DRAWING

Some embodiments of this invention, illustrating all its features, will now be discussed in detail. These embodiments depict the novel and non-obvious rescue device using a kite-type balloon as shown in the accompanying drawing, which is for illustrative purposes only. This drawing includes the following figures (Figs.), with like numerals indicating like parts:

FIG. 1 is a cross-sectional view of one embodiment of the rescue device of this invention.

FIG. 2 is an enlarged cross-sectional view of the inflator valve assembly used in the rescue device of this invention.

FIG. 3 is a plan view of the kite-type balloon of this invention in an inflated condition.

FIG. 3A is a fragmentary view taken along line 3A of FIG. 3 showing the self-sealing inflation port of the kite-type balloon at head end of the balloon.

FIG. 3B is a fragmentary view of the tail end of an alternate embodiment the kite-type balloon of this invention with its a self-sealing inflation port at the tail end of the balloon.

FIG. 4 is a cross-sectional view of the inflated kite-type balloon taken along line 4-4 of FIG. 3.

FIG. 5 is a cross-sectional view of the inflated kite-type balloon taken along line 5-5 of FIG. 3.

FIG. 6 is a side elevational view of the inflated kite-type balloon taken along line 6-6 of FIG. 3 showing the balloon aloft during windy weather conditions.

FIG. 7 is a plan view of the kite-type balloon illustrated in FIG. 3 in a deflated, partially compacted condition with one lateral side partially rolled up.

FIG. 8 is a plan view of the deflated kite-type balloon illustrated in FIG. 7 in a partially compacted condition with both lateral sides partially rolled up.

FIG. 9 is a perspective view of the deflated kite-type balloon illustrated in FIG. 7 in a partially compacted condition with both lateral sides completely rolled up and the tail end of the balloon partially rolled up towards the head end of the balloon.

FIG. 10 is a perspective view of the deflated kite-type balloon illustrated in FIG. 7 in a completely compacted condition.

### DETAILED DESCRIPTION OF SOME EMBODIMENTS OF THIS INVENTION

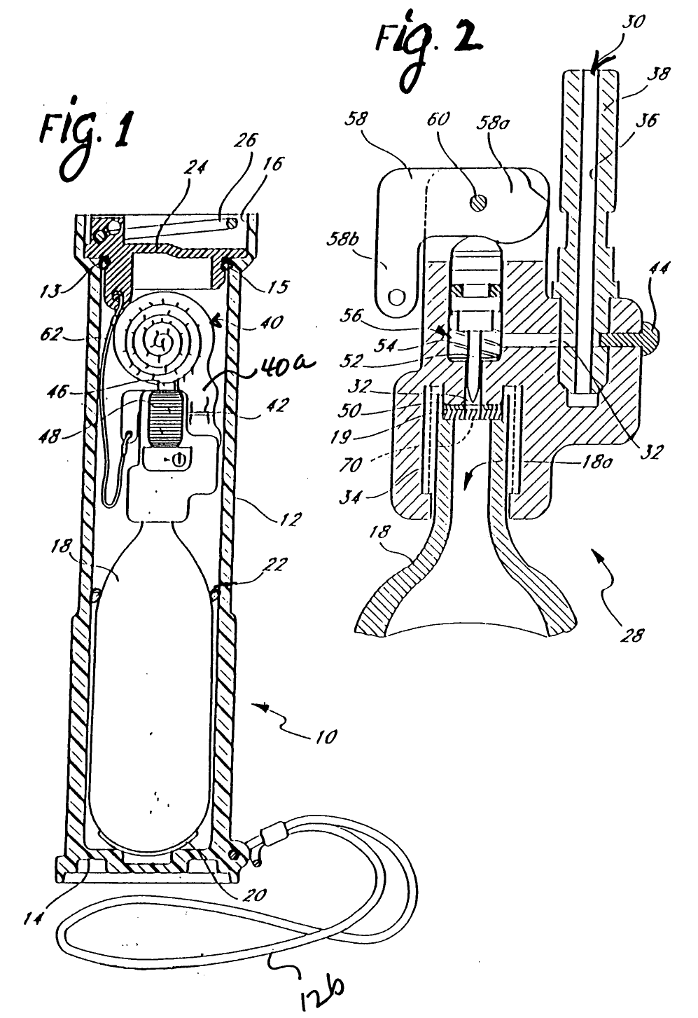

As best illustrated in FIGS. 1 and 2, the rescue device 10 of this invention includes a housing 12 holding a deflated balloon 40 in a compacted condition to fit within the housing 12. The balloon inflates upon removal from the housing 12.

The housing 12 has a closed bottom end 14 and an open top end 16. The housing 12 may have on its side a belt clip (not shown) that allows a user to clip the device 10 to his or her belt, and a wrist strap 12b for facilitating carrying the device. Contained within the housing 12 is a cylinder 18 of pressurized, lighter-than air gas such as helium. There is a pad 20 disposed between the bottom of the cylinder 18 and the closed bottom end 14 of the housing 12 on which the end of the cylinder 18 rests and a retainer ring 22 force fitted between the wall of the housing 12 and an intermediate section of the cylinder 18. The one end of the cylinder has a seal 19 (FIG. 2), which, when pierced, allows gas to escape from the cylinder 18. A cover or cap 24 closes off the open top end 16 of the housing 12, and an “O” ring seal 13 in a groove 15 provides a water-tight seal. A pull ring 26 is attached to the exterior of the cap 24, allowing the user to pull the cap from the open top end 16 of the housing 12. The balloon 40 inflates with the removal of the cap 24.

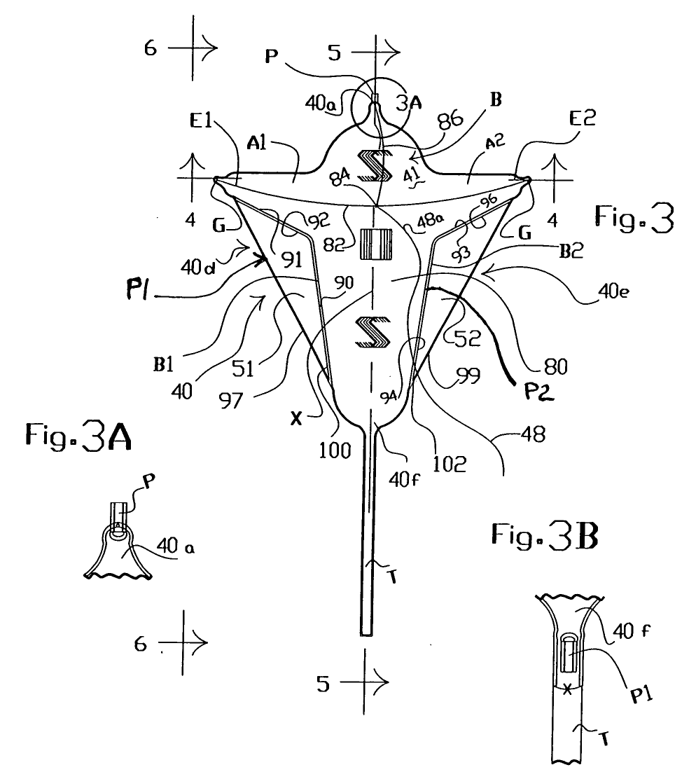

As depicted in detail in FIG. 2, an inflator valve 28 is connected to an outlet 18a of the cylinder 18. It includes a valve body 30 having an opening 34 that is in communication with the outlet 18a and a stem 38 including a passageway 36. There is a passageway 32 extending between the openings 34 and into the passageway 36. As shown in FIG. 2, a kite-type balloon 40 with a self-sealing inlet end 40a is used in this invention. This self sealing inlet end 40a includes an inflation port P. The balloon 40 has a self-sealing inlet end 40a as described in U.S. Pat. No. 4,917,646. The inlet end 40a of the balloon 40 is retained on the stem 38 by a clamping member or retainer ring 42, and the stem is held in position in the valve body 30 by a set screw 44. Mounted on the valve body 30 is a spool 46 (FIG. 2) which has wound about it a secured fish line 48. One end (not shown) of the secured line 48 is attached to the spool 46 and the other end 48a of the secured line is attached to the balloon 40 as shown in FIG. 3.

As depicted in FIG. 2, in the passageway 32 is a thin annular gasket 50. A plunger pin 52 is received in a bore 54 in the valve body 30 and is spring biased by a compression spring 56 that normally urges the plunger pin outward from the bore. A valve actuator includes an L-shaped lever 58 attached to the valve body 30 by a pivot rod 60. This lever 58 has one arm 58a resting on top of the head of the plunger pin 52. There is one end of a pull cord 62 (FIG. 1) attached to the cap 24 and another end attached to the other arm 58b of the lever 58. Upon removing the cap 24, the pull cord 62 yanks the arm 58b of the lever 58 causing it to rotate in a clockwise direction as shown in FIG. 2. The arm 58a of the lever 58 pivots about the rod 60, forcing the plunger pin 52 downward against the action of the spring 56 to pierce the seal 19, inflating the balloon 40.

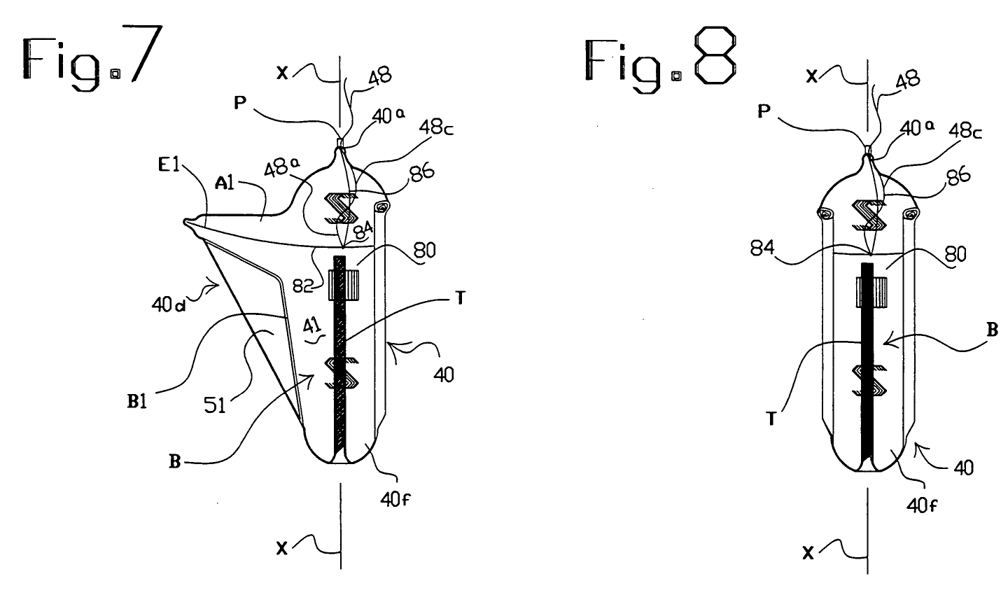

The deflated balloon 40 is folded and rolled up as illustrated in FIGS. 7 through 10. Specifically, the deflated balloon 40 is generally flat, and upon being inflated has a substantially triangular configuration as shown in FIG. 3. It includes opposed faces 41, 42, lateral sides 40d, 40e, and opposed ends, the self sealing inlet end 40a (also referred to as the head end) and the tail end 40f. As shown in FIGS. 7 and 8, when deflated, each lateral side 40d and 40e of the balloon 40 is rolled inward towards the balloon's longitudinal axis X. Next, as depicted in FIGS. 9 and 10, the tail end 40f of the balloon, with the lateral sides rolled up to the longitudinal axis X, is rolled towards the head or self sealing inlet end 40a. This manner of rolling the balloon 40 insures that it will open when inflated and be forced from the open end 16 of the housing 12 and be released to the atmosphere solely under the influence of the pressurized gas filling the balloon. The balloon 40 may have surface portions covered with a thin, foil-like, metal film that is light and RADAR reflective. Thus, in the day light, the metal film will reflect light like a mirror. At night, radar can be used to detect the balloon 40. The balloon 40 may also have the words “HELP”(not shown) printed on one face 24 and international distress symbol “S.O.S” printed on the other face 41. The balloon 40 typically is made from two sheets of plastic such as, for example, Mylar®, overlying each other and bonded together along abutting sheet edges forming the perimeter P1 of the balloon 40 and abutting sheet edges forming the perimeter P2 of a central hollow body B.

As FIGS. 3 through 6 depicted, the balloon 40, as it is inflated, unfurls a pair of sheet type, triangular configured sail elements S1 and S2 extending from the hollow body B. The sail elements S1 and S2 are attached to the opposed sides B1 and B2 of the balloon 40. In addition to the sail elements S1 and S2, the balloon 40 includes a tail T attached to the tail end 40f of the balloon 40. The sail element S1 is attached to the side B1, and the sail element S2 is attached to the side B2. The hollow body B includes a central beam 80 that extends between the head or self-sealing inlet end 40a and the tail end 40f, and tapers inwardly towards the tail end. There are opposed arms A1 and A2 that extend outwardly from an intermediate portion of the beam 80, each at a substantially right angle to the longitudinal axis X and each tapering inwardly towards their respective outer ends E1 and E2. The balloon 40 is symmetrical about the longitudinal axis X. As best illustrated in FIG. 3A, the inflation port P is near the head or self-sealing end 40a. Or, as illustrated in FIG. 3B, the self-sealing inflation port P1 may be located near the tail end 40f.

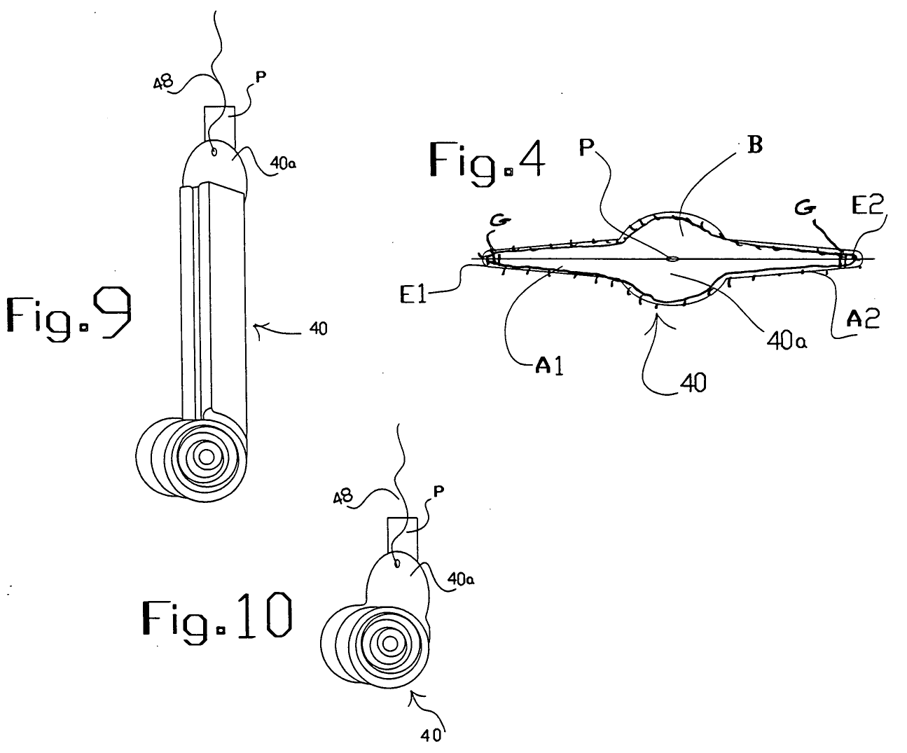

In one embodiment, the hollow body B has a substantially cross configuration and the pair of opposed arms A1 and A2 are aligned and intersected the beam 80. As depicted best in FIGS. 4, 5 and 6, the entire hollow body B, including the arms A1 and A2 and beam 80, is filled with the gas upon inflation of the balloon 40. As illustrated in FIG. 3, the sail element S1 has an edge 91 connected to the arm Al and the side B1, having an inner edge 90 attached to the lower portion of the beam 80, extending between the underside 92 of the arm A1 and the tail end 40f. The other sail element S2 has an edge 93 connected to the arm A2 and the other side B2, having an inner edge 94 attached of the lower portion of the beam 80, extending between the underside 96 of the arm A2 and the tail end 40f. Adjacent each of edges 91 and 93 of each sail element S1 and S2 is, respectively, an outer edge 97 and 99. Each of these edges 97 and 99 tapers inward to terminate at an acute angle tip 100 and 102, respectively, near the tail end 40f. The tail T has a length such that, when folded inward as shown in FIGS. 7 and 8, does not intersect with the connector line 82.

Each arm A1 and A2 has at its respective outer end E1 and E2 a grommet G therein and a connector line 82 extends between these outer ends and is tied to the grommets G. The end 48a of the secured line 48 is connected to an intermediate, preferably central, portion of the connector line 82 in a knot 84 (FIG. 3). Another connector line 86 extends between the knot 84 and the head or self-sealing end 40a. The use of the connector lines 84 and 86 is desirable because they stabilize the inflated balloon 40 when aloft in windy weather conditions.

When compacting the balloon 40 as shown in FIG. 7 and 8, a portion 48c of the secured line 48 that extends from the end 48a connected to the knot 84 is positioned to lie substantially along or nearby the longitudinal axis X and is oriented to extend outward from the head end 40a including the inflation port P of the compacted balloon 40. If the inflation port P is at the tail end 40f as illustrated in FIG. 3B, the portion 48c of the secured line 48 is positioned to lie substantially along or nearby the longitudinal axis X, but is now oriented to extend outward from the tail end of the compacted balloon.

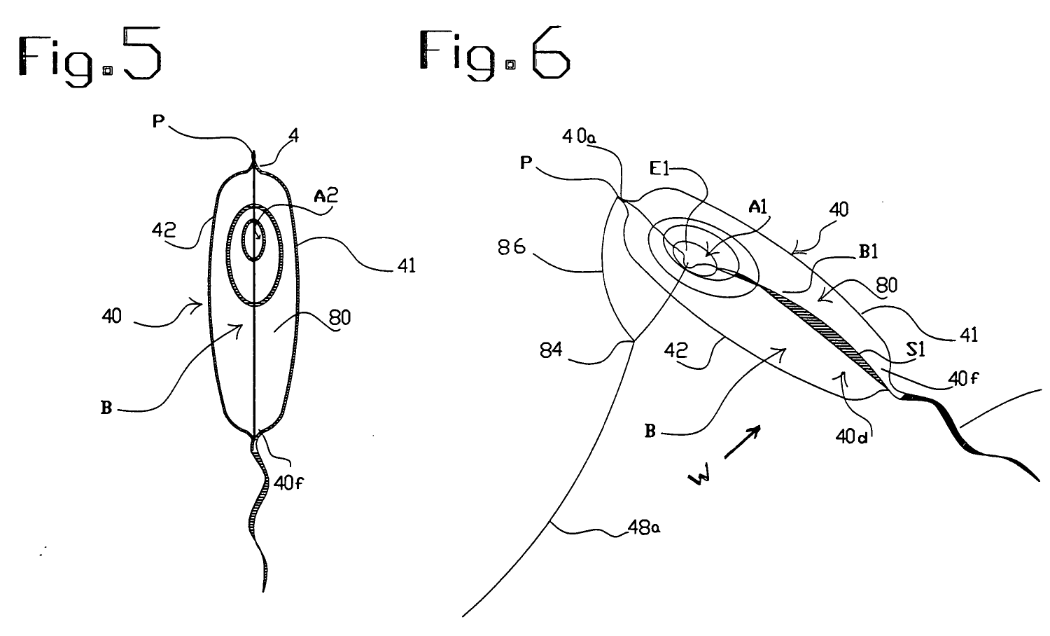

To use the rescue device 10 of this invention, the injured or lost person simply grasps the pull ring 26 and pulls the cap 24 from the open end 16 of the housing 12. Simultaneously, the L-shaped lever 58 pivots to depress the plunger pin 52, so that the tip of the plunger pin 52 punctures the seal 19. Thus, with one single action of the user, the device 10 is actuated. Upon release of the cap 24, the puncture pin 52 is returned by the action of the spring 56 to the position shown in FIG. 2. This creates an opening 70 in the seal 19, allowing the pressurized lighter-than-air gas to flow through the passageways 32 and 36 into the self-sealing inlet end 40a of the balloon 40, inflating the balloon 40 to its fully inflated condition as depicted in FIG. 3. As the balloon 40 is inflated, it is forced out of the housing 12 through the uncovered, open end 16 and rises in the atmosphere, with the gas being retained in the balloon due to the self sealing feature at the inlet end 40a. As the gas fills the balloon 40, the internal pressure causes the self-sealing inlet 40a to seal. The pressure inside the cylinder 18 ranges between 2000 and 3000 psig. This is sufficient to insure that the balloon 40 is inflated to maximum capacity under a wide and varying range of temperature and pressure encounter at different altitudes and in different environments. The secured line 48 maintains attached to both the balloon 40 and the device 10. The device 10 has sufficient weight so that the balloon 40 does not lift the device 10 into the atmosphere. As shown in FIG. 6, if weather conditions are windy, the unfurled sail elements S1 and S2 catch wind blowing in the direction W, so the balloon 40 behaves as a kite. Thus, the use of the kite-type balloon 40 overcomes the problem of maintaining a balloon aloft under windy weather conditions.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A rescue device that marks a location, comprising
a deflated kite-type balloon having a self-sealing inflation port,
an inflator valve in communication with the self-sealing inflation port of the deflated balloon, and
a container which holds a pressurized, lighter than air gas, said container having an outlet port in communication with the inflator valve, said inflator valve upon being opened causing the lighter than air gas to enter the deflated balloon to inflate the balloon.

2. The rescue device of claim 1 where balloon comprises a central hollow body with opposed sides, said hollow body being filled with the gas upon inflation of the balloon, and a pair of sail elements, one sail element attached to one opposed side and the other element attached to the other opposed side.

3. The rescue device of claim 1 where balloon has a substantially triangular configuration.

4. The rescue device of claim 1 where balloon includes a tail.

5. The rescue device of claim 1 where the hollow body has a central longitudinal axis and the balloon is substantially symmetrical about said axis.

6. The rescue device of claim 1 where balloon comprises
a hollow body with a head end, a tail end, and opposed outwardly extending arms, said hollow body being filled with the gas upon inflation of the balloon, and
a pair of sail elements connected to the hollow body, one sail element extending between one arm and the tail end and the other sail element extending between the other arm and the tail end.

7. The rescue device of claim 6 where the hollow body has a central longitudinal axis extending between the head end and the tail end and the balloon is substantially symmetrical about said axis.

8. The rescue device of claim 6 where each arm has an outer end and a first connector line extends between said outer ends and a second connector line extends between the head end and an intermediate portion of the first connector line.

9. The rescue device of claim 8 including a third line adapted to secure the balloon at the location, said third line including an end connected to an intermediate portion of the first connector line.

10. The rescue device of claim 9 where, with the balloon is in a predetermined compact condition, a portion of the third line extends outward from the compacted balloon.

11. The rescue device of claim 6 where a tail is attached to the tail end of the hollow body and the self-sealing inflation port is near said tail end.

12. The rescue device of claim 6 where a tail is attached to the tail end of the hollow body and the self-sealing inflation port is near the head end.

13. The rescue device of claim 6 where the sail elements each have a substantially triangular configuration.

14. The rescue device of claim 1 including a line adapted to secure the balloon at the location and a housing with the deflated balloon in said housing in a predetermined compact condition.

15. The rescue device of claim 14 where
said balloon has opposed faces, opposed lateral sides, opposed ends, and a longitudinal axis extending between said opposed ends, said inflation port being nearby one of said ends of the balloon,
each of said lateral sides being rolled inward against one of said faces and towards the longitudinal axis so that said balloon is a partially rolled balloon, which is then rolled inward from the end opposed to the inflation port, towards the inflation port, into said predetermined compact condition.

16. The rescue device of claim 15 including a detachable cover member closing an open end of the housing and a valve actuator connected to the cover member so that, upon removal of the cover member from the open end of the housing, the valve actuator opens the inflator valve causing the lighter than air gas to enter the compacted balloon to inflate the balloon, which exits the open end of the housing solely under the influence of a pressurized gas.

17. The rescue device of claim 16 where the housing encloses the container, the inflator valve, and the compacted balloon.

18. A rescue device that marks a location, comprising
a housing having an open end,
a deflated kite-type balloon having a self-sealing inflation port, said balloon being in a predetermined compact condition and positioned within the housing,
said balloon comprising
a hollow body that is filled with the gas upon inflation of the balloon,
a sail element attached to the body, and
a tail attached to an end of the balloon,
an inflator valve in communication with the inflation port of the deflated balloon,
a container which holds a pressurized, lighter than air gas, said container having an outlet port in communication with the inflator valve, said inflator valve upon being opened causing the lighter than air gas to enter the deflated balloon to inflate the balloon.

19. The rescue device of claim 18 including a secured line that secures the inflated balloon to the device.

20. A rescue device that marks a location, comprising
a housing having an open end,
a deflated kite-type balloon in the housing and having a self-sealing inflation port,
said balloon comprising
a hollow body with a head end, a tail end, and opposed outwardly extending arms each having an outer end, said hollow body being filled with the gas upon inflation of the balloon,
a pair of sail elements connected to the hollow body, one sail element extending between one arm and the tail end and the other sail element extending between the other arm and the tail end, and
an elongated tail connected to the tail end,
an inflator valve in communication with the inflation port of the deflated balloon,
a container which holds a pressurized, lighter than air gas, said container having an outlet port in communication with the inflator valve, said inflator valve upon being opened causing the lighter than air gas to enter the deflated balloon to inflate the balloon,
a secured line that secures the inflated balloon to the device, and
a first connector line that extends between the outer ends of the arms,
said secured line including an end connected to an intermediate portion of the first connector line.

21. The rescue device of claim 20 including a second connector line that extends between the head end and an intermediate portion of the first connector line.

22. The rescue device of claim 20 where the hollow body has a central longitudinal axis extending between the head end and the tail end and the balloon is substantially symmetrical about said axis.

23. The rescue device of claim 22 where balloon has a substantially triangular configuration.

24. The rescue device of claim 20 where the deflated balloon is in a predetermined compacted condition to fit within the housing.

25. The rescue device of claim 24 where said compacted balloon includes
a longitudinal axis extending between the head end and tail end and has opposed faces, opposed lateral sides and the inflation port is nearby one of said ends,
said tail is folded inward lengthwise towards said head end substantially along the longitudinal axis and each of said lateral sides is rolled inward against one of said faces and towards the longitudinal axis so that said balloon is a partially rolled balloon, which is then rolled inward from the end opposite the inflation port towards said one end including the inflation port, into said predetermined compact condition,
a portion of the secured line that extends from the end connected to the intermediate portion of the first connector line is positioned to lie substantially along or nearby the longitudinal axis and to extend outward from the compacted balloon from said one end including the inflation port.

26. The rescue device of claim 25 where the tail has a length that when folded inward does not intersect with the connector line.

27. The rescue device of claim 20 including a detachable cover member closing the open end of the housing and a valve actuator connected to the cover member so that, upon removal of the cover member from the housing, the valve actuator opens the inflator valve causing the lighter than air gas to enter the compacted balloon to inflate the balloon, which exits the open end of the housing solely under the influence of a pressurized gas.

28. The rescue device of claim 27 where the housing encloses the container, the inflator valve, and the compacted balloon.

29. A rescue device that marks a location, comprising
a housing having an open end,
a deflated kite-type balloon having a self-sealing inflation port, said balloon positioned within said housing,
said balloon comprising
a hollow inflatable body having a substantially cross configuration with a pair of opposed arms intersecting a beam element, said arms having outer ends, and
a pair of sail elements, each sail element connected to one arm and to a side of the beam element, and
an elongated tail connected to the tail end,
an inflator valve in communication with the inflation port of the deflated balloon,
a container which holds a pressurized, lighter than air gas, said container having an outlet port in communication with the inflator valve, said inflator valve upon being opened causing the lighter than air gas to enter the deflated balloon to inflate the balloon,
a secured line that secures the inflated balloon to the device, and
a connector line that extends between outer ends of the arms,
said secured line including an end connected to an intermediate portion of the connector line.

30. A kite-type balloon comprising
a hollow body adapted to be filled with the gas upon inflation of the balloon, and
a sail element connected to the hollow body.

31. The kite-type balloon of claim 30 where said balloon has a substantially triangular configuration.

32. The kite-type balloon of claim 30 where balloon includes a tail.

33. The kite-type balloon of claim 30 where at least a portion of the balloon is radar reflective.

34. The kite-type balloon of claim 30 where body has opposed lateral sides and a sail element is attached to each lateral side.

35. The kite-type balloon of claim 34 where the hollow body has a central longitudinal axis and the balloon is substantially symmetrical about said axis.

36. A kite-type balloon comprising
a hollow body with a head end, a tail end, and opposed outwardly extending arms, said hollow body adapted to be filled with the gas upon inflation of the balloon, and
a pair of sail elements connected to the hollow body, one sail element extending between one arm and the tail end and the other sail element extending between the other arm and the tail end.

37. The kite-type balloon of claim 36 including a tail attached to the tail end of the hollow body and the hollow body has a central longitudinal axis extending between the head end and the tail end and the balloon is substantially symmetrical about said axis.

38. The kite-type balloon of claim 36 where at least a portion of the balloon is radar reflective.

39. The kite-type balloon of claim 36 where said balloon has a substantially triangular configuration.

40. The kite-type balloon of claim 36 where the sail elements each have a substantially triangular configuration.

41. A kite-type balloon comprising
a hollow inflatable body having a substantially cross configuration including a pair of opposed arms intersecting a beam element, and
a pair of sail elements, each sail element connected to one arm and to a side of the beam element.

42. The kite-type balloon of claim 41 where each sail element has a substantially triangular configuration.

43. The kite-type balloon of claim 41 where the beam element has a longitudinal axis and the balloon is substantially symmetrical about said axis.

44. The kite-type balloon of claim 41 including a tail attached to an end of the inflatable body and where each arm has an outer end and the beam element has a head end and a tail end, and each sail element has an outer edge tapering inward to terminate at or near the tail end.

45. The kite-type balloon of claim 44 including
a first connector line that extends between the opposed outer ends of the arms, and
a second connector line that extends between the head end and an intermediate portion of the first connector line.

46. A method of marking an individual's location to facilitate rescue even under windy weather conditions, comprising
providing
(a) a source of lighter than air gas,
(b) a deflated kite-type balloon having a self-sealing inflation port adapted to be placed in communication with the source of lighter than air gas to inflate the kite-type balloon, and
(c) a line adapted to secure the balloon at the location, and
when rescue is desired, inflating the deflated kite-type balloon with said gas from said source and releasing the inflated kite-type balloon with the line secured to the balloon and at or near said location.

47. The method of claim 46 where at least a portion of the kite-type balloon is radar reflective.

48. The method of claim 46 where the kite-type balloon comprises
a hollow body adapted to be filled with the gas upon inflation of the balloon, and
a sail element connected to the hollow body.

49. The method of claim 46 where the kite-type balloon comprises
a hollow body with a head end, a tail end, and opposed outwardly extending arms, said hollow body adapted to be filled with the gas upon inflation of the balloon, and
a pair of sail elements connected to the hollow body, one sail element extending between one arm and the tail end and the other sail element extending between the other arm and the tail end.

50. The method of claim 46 where the kite-type balloon comprises
a hollow inflatable body having a substantially cross configuration including a pair of opposed arms intersecting a beam element, and
a pair of sail elements, each sail element connected to one arm and to a side of the beam element.
